(19) United States
(12) Patent Application Publication
(10) Pub. No.: US 2005/0267793 A1
(43) Pub. Date: Dec. 1, 2005

(54) METHOD AND SYSTEM FOR ENHANCED EFFICIENCY IN MEETING STAFFING REQUIREMENTS

(75) Inventors: Robert Earl Campbell, McKinney, TX (US); Dillon Brent Durham, Plano, TX (US); Rodney A. Shifflette, Dallas, TX (US)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(73) Assignee: SYMBIO SOLUTIONS, INC., Dallas, TX (US)

(21) Appl. No.: 10/908,764

(22) Filed: May 25, 2005

Related U.S. Application Data
(60) Provisional application No. 60/574,295, filed on May 25, 2004.

(51) Int. Cl. G06F 17/60

(52) U.S. Cl. 705/9

(57) ABSTRACT

A method and computer program is provided for enhanced efficiency in meeting staffing requirements that includes receiving one or more staffing requirements for employment positions from an employer, preparing one or more candidate lists, preparing credential information for each available employee candidate, and sending the candidate lists and corresponding credential information to the employer. Each candidate list identifies one or more available employee candidates meeting the staffing requirements from each of a plurality of staffing agencies.

### CROSS REFERENCE TO RELATED APPLICATIONS

The present application claims priority to U.S. provisional application Ser. No. 60/574,295 filed in the U.S. Patent and Trademark Office on May 25, 2005. The above provisional patent application is hereby incorporated by reference.

### BACKGROUND OF THE INVENTION

The present invention relates to employer staffing and more particularly to a method and computer system for enhanced efficiency in meeting staffing requirements.

### DISCUSSION OF THE BACKGROUND

Employers must continually recruit and hire new employees for both temporary and permanent positions. There is also often a need for employers to hire employees temporarily to fill time slots that become open unexpectedly, such as if an employee becomes ill or if there is a sudden increase in staffing requirements. For instance, hospitals and other health care providers must continually recruit and hire new employees, such as nurses, lab technicians and medical equipment technicians, for both temporary and permanent positions. Frequently, nurses or other health care workers must be hired temporarily to fill time slots that become open unexpectedly, such as if a scheduled nurse becomes ill or if there is a sudden increase in hospital patient levels.

In these situations, the time available to locate replacement employees may be very short. However, many employment positions require that the employee have a license, a certification, a particular skill and/or a particular level of experience, in order to be qualified. For instance, health care workers such as nurses must typically be licensed or certified, and may need to possess a particular skill or level of experience in order to be qualified for an available employment position. As such, a great deal of time is required to determine whether a nurse is or is not qualified for a particular position.

The need for an employer to fill an employment position often conflicts with the need that the candidate have the required credentials and other qualifications. This conflict occurs in many industries including the hospital industry where a hospital's need to fill nursing positions often conflicts with the need to ensure that a candidate nurse has the required credentials. Obviously, these types of conflicts can also be encountered in connection with other types of health care workers including lab technicians and medical equipment technicians. Such conflicts are exasperated where there is a need for the employee candidate to be employed within a short time frame and the qualifications of the employee candidate must be verified prior to employment.

In the past, the selection of candidates to fill available employment positions having highly specialized credentials and other qualifications often required weeks or longer.

### SUMMARY OF THE INVENTION

Accordingly, one object of the present invention is to provide a method for enhanced efficiency in meeting staffing requirements that includes receiving one or more staffing requirements for employment positions from an employer, preparing one or more candidate lists, preparing credential information for each available employee candidate, and sending the candidate lists and corresponding credential information to the employer. Each candidate list identifies one or more available employee candidates meeting the staffing requirements from each of a plurality of staffing agencies.

Another object of the present invention is to provide a computer system for enhanced efficiency in meeting staffing requirements that includes one or more processors and a computer readable medium connected to the processors. The computer readable medium includes processor instructions configured to be read by the processors and thereby cause the processors to receive one or more staffing requirements for employment positions from an employer, prepare one or more candidate lists, prepare credential information for each available employee candidate, and send the candidate lists and corresponding credential information to the employer. Each candidate list identifies one or more available employee candidates meeting the staffing requirements from each of a plurality of staffing agencies.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1a is a block diagram graphically depicting a system operable to improve efficiency and reduce the time frame required to meet staffing requirements according to an embodiment of the present invention;

FIG. 1b is a block diagram graphically depicting a system operable to improve efficiency and reduce the time frame required to meet staffing requirements according to another embodiment of the present invention;

FIG. 2 is a block diagram graphically depicting a computer system according to an embodiment of the present invention;

FIG. 3a is a flow chart showing a process for improving efficiency and reducing the time frame required to meet staffing requirements according to an embodiment of the present invention; and

FIG. 3b is a flow chart showing the process for preparing a list of available candidates selected based on a given staffing requirement, as shown in FIG. 3a, according to an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

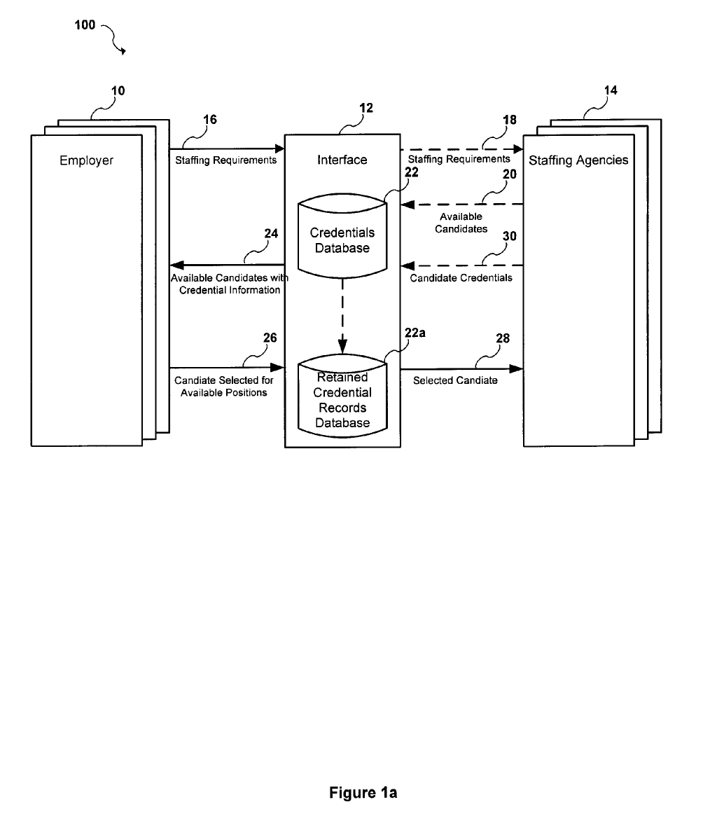

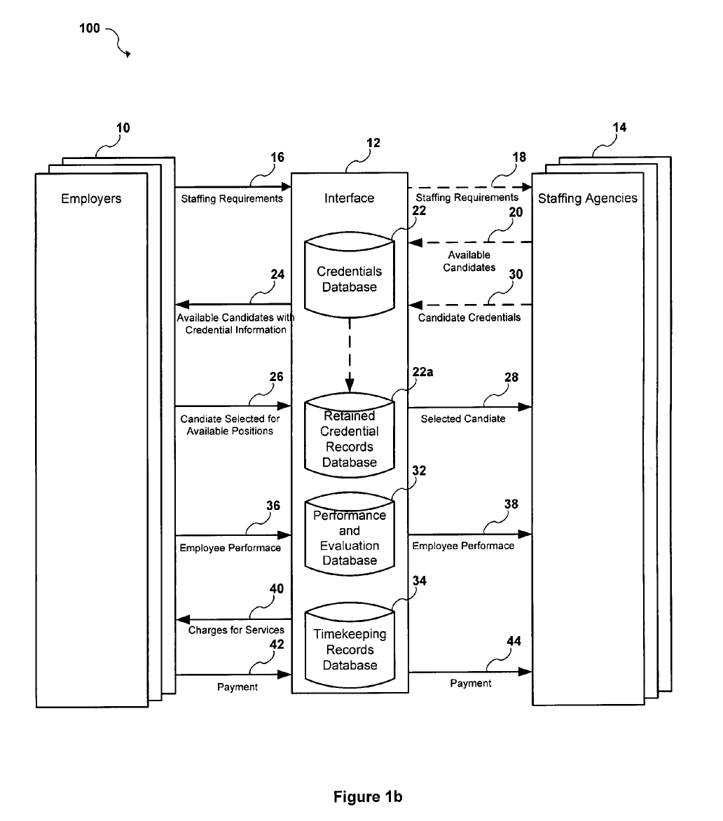

Referring to FIG. 1a, a block diagram graphically depicting a system operable to improve efficiency and reduce the time frame required to meet staffing requirements according to an embodiment of the present invention is shown. As shown in FIG. 1, interface 12 is logically configured between one or more employers 10 and one or more staffing agencies 14. Staffing agencies 14 are companies or businesses that contractually or by other means represent individuals, such as nurses or other health care workers, available for employment. Employers 10 include, but are not limited to, health care providers.

Interface 12 is provided with a computer system that is logically connected to the computer systems of one or more employers 10 and to the computer systems of one or more staffing agencies 14. According to the present invention, data can be quickly exchanged between interface 12 and one or more employers 10, and between interface 12 and one or more staffing agencies 14.

When one or more employers 10 have available employment positions, the specific staffing requirements are transmitted to interface 12 using communication path 16. Interface 12 may then transmit the staffing requirements to one or more staffing agencies 14 using communication path 18. Upon receiving the staffing requirements, each staffing agency 14 prepares a list of available candidates that are considered qualified in view of the staffing requirements. The staffing agencies 14 then transmit the candidate list to interface 12 using communication path 20. In one embodiment, interface 12 maintains one or more updated candidate lists based on staffing requirements from staffing agencies 14 or other sources in database 22a. If interface 12 already has a candidate list that meets the specific staffing requirement in database 22a, then interface 12 may utilize that candidate list without transmitting the staffing requirements to the staffing agencies 14.

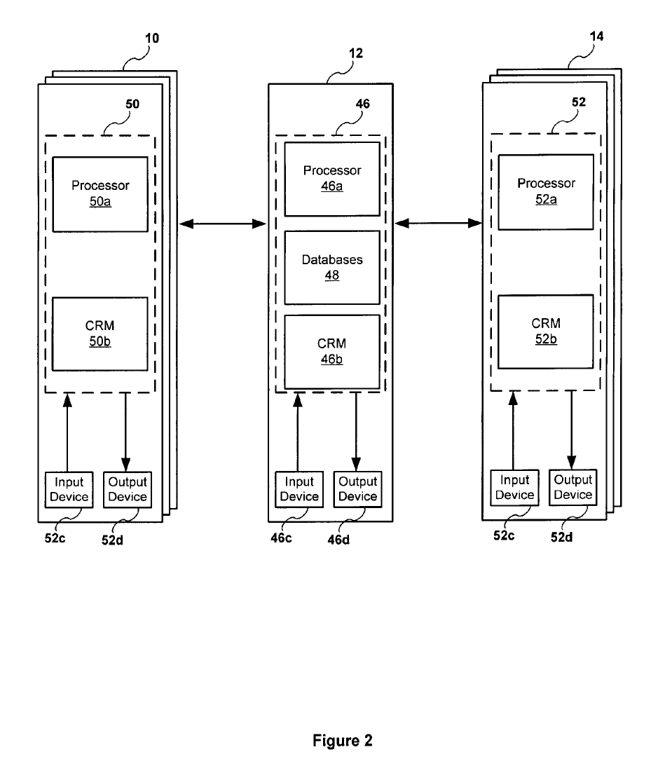

Referring to FIG. 2, a block diagram graphically depicting a computer system according to an embodiment of the present invention is shown. Staffing agencies 14 operate computer 52 to prepare a candidate list either automatically or manually. Computer 52 compares staffing requirements with the credentials of one or more individuals that it represents, and prepares a candidate list of those individuals whose credentials match the requirements.

Interface 12 may be configured to include database 22. Database 22 maintains information which pertains to the qualifications and credentials of all employees represented by staffing agencies 14. Database 22 also includes information previously sent to interface 12 from the staffing agencies 14. In one embodiment, the credentials information in database 22 is continually updated from one or more staffing agencies 14 using communication path 30 and/or from other data sources such that the data pertaining to employee candidates is always current. The data maintained in database 22 includes, but is not limited to, personal information, credential information and/or other documents in electronic form. The credentials information for a particular employee candidate may include education and training data, relevant work experience, and/or electronic images of licenses, certifications or other documents relating to the qualifications of the employee candidate.

Upon receiving the list of candidates from one or more staffing agencies 14, interface 12 is operated to access the credentials information for each employee candidate in database 22, and to combine such information with the candidate's name. The combined information is then sent to the appropriate employer 10 using communication path 24. By providing the credentials information to the employer 10 along with the list of available employee candidates, the employer 10 may quickly determine whether or not employee candidates are acceptable for the available employment positions. The list of candidates found to be acceptable and selected by the employer 10 are sent to interface 12 using communication path 26 and then routed to staffing agencies 14 using communication path 28. According to the present invention, by making the credentials information immediately available to the employer 10 in a readily useable form, the time required to locate and hire qualified employees can be reduced from a period of days to a period of hours or even minutes. In one embodiment, the entire process is completed in under a minute. According to this embodiment, the data necessary for employers 10 to make selections is provided automatically by interface 12 and/or staffing agencies 14.

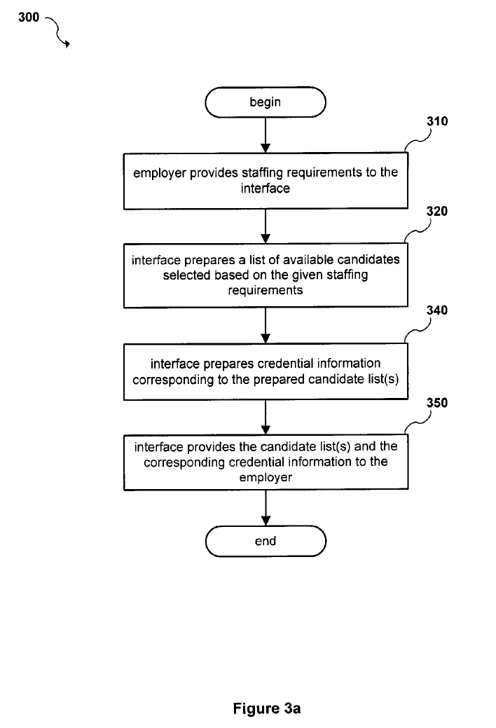

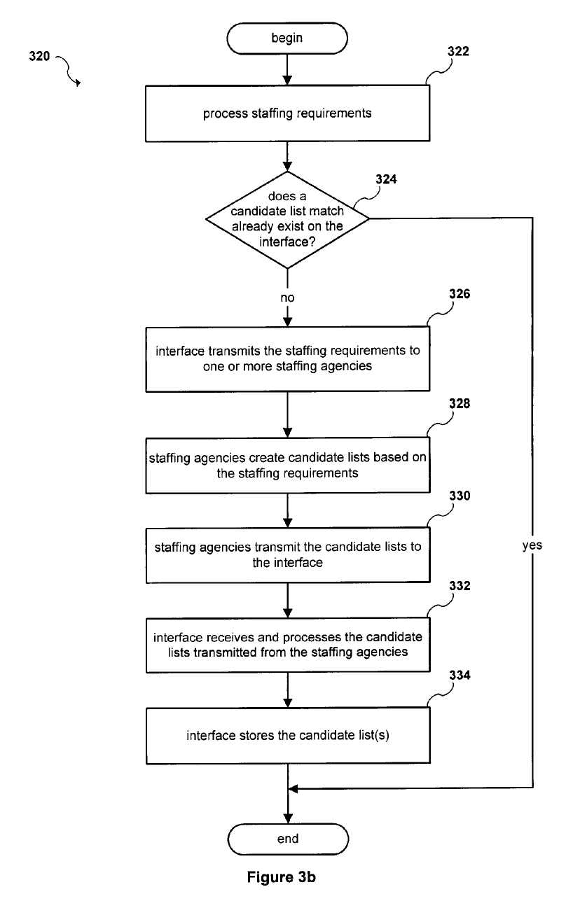

Referring to FIG. 3a, a flow chart showing a process for improving efficiency and reducing the time frame required to meet staffing requirements according to an embodiment of the present invention is shown. At block 310, an employer 10 provides staffing requirements to interface 12. One or more available candidate lists that are based on the given staffing requirements are prepared at block 320, and as further shown in FIG. 3b below. At block 340, credential information corresponding to the one or more candidate lists is prepared. The one or more candidate lists and the corresponding credential information is provided to the employer 10 requesting such information at block 350.

Referring to FIG. 3b, a flow chart showing the process for preparing a list of available candidates selected based on a given staffing requirement according to an embodiment of the present invention is shown. At block 322, the staffing requirements are processed by interface 12. This may include, but is not limited to, reformatting the data or adding additional data to the staffing requirements. An optional determination may be made to determine whether there are any candidate lists that match the staffing requirements in database 22a, as shown at decision block 324. If one or more matching candidate lists exist in database 22a, then no further processing is required. At block 326, interface 12 transmits the staffing requirements to one or more staffing agencies 14. The staffing agencies 14 create candidate lists based on the given staffing requirements at block 328. At block 330, one or more staffing agencies 15 transmit the candidate lists to interface 12. Interface 12 receives and processes the candidate lists at block 332. Optionally, interface 12 may store the candidate lists in database 22a at block 334.

According to the present invention, employers 10 need not and often will not know the identity of the staffing agency 14 that provided the employee candidate until after the employee candidate has been selected by the employer 10. Thereby, the present invention reduces the possibility of bias and other problems associated with recruiting employees.

In one embodiment, interface 12 includes database 22a which maintains detailed information regarding the credentials and/or qualifications of one or more employees hired by a particular employer 10 through interface 12. Information in database 22a may either be retained on an indefinite basis or for a specified period, such as 7 years. The information may be made available to the employer 10 upon demand. An employer 10 that is required to show that all workers who were previously employed met certain qualifications may utilize such a configuration. Database 22a of interface 12 may also be used to provide information regarding individuals who were previously employed by the employer 10 for only a brief period of time, such as temporary replacements.

In one embodiment, interface 12 includes database 32 which maintains performance information received from employers 10 regarding employees hired through any of the staffing agencies 14 using communication path 36. The performance information may also be forwarded to the appropriate staffing agency 14 using communication path 38. This performance information may then be used by the staffing agencies 14 to make future candidate lists and/or employee assignments. Interface 12 may use the performance information or any other information to filter the candidate lists that are provided by the staffing agencies 14 such that modified candidate lists are produced. For instance, interface 12 may eliminate certain employee candidates based on their previous performance information.

In one embodiment, interface 12 includes database 34. Database 34 is used to maintain the time worked by employees represented by staffing agencies 14. In this embodiment, interface 12 may be operated to periodically access the time records in timekeeping database 34 to prepare billing statements for employee services. A charge or billing statement for employee services is sent from interface 12 to employers 10 using communication path 40 and the payment then is received from the employers 10 to interface 12 using communication path 42. The payment may then be distributed to the appropriate staffing agency 14 using communication path 44.

In another embodiment, interface 12 is configured to provide other data to the employers 10. According to this embodiment, interface 12 acts as an information broker between the employers 10 and the staffing agencies 14. For instance, when an employer 10 is seeking assistance, the employer 10 can transmit related information, such as conditions of employment, to interface 12. Interface 12 may then provide the information to one or more staffing agencies 14. For instance, if employers 10 previously answered a question received from one staffing agency 14, then the question and answer may be provided to all other staffing agencies 14. Interface 12 may also be configured to act as an intermediary in scheduling interviews between employers 10 and employee candidates who are represented by staffing agencies 14.

Interface 12 is provided with a computer 46 having a processor 46a, a computer readable medium (CRM) 46b and input and output devices 46c and 46d, respectively, for enabling an operator to communicate with computer 46. The databases 22, 22a, 32 and 34, described above, are collectively shown in FIG. 2 as databases 48 of computer 46.

FIG. 2 further shows computers 50 and 52 logically included by employers 10 and staffing agencies 14, respectively. These computers are respectively provided with processors 50a and 52a, CRMs 50b and 52b, input devices 50c and 52c and output devices 50d and 52d. Computer 46 is logically connected between computers 50 and 52 such that the communication paths as described above are established. However, other communication paths are obviously possible within the scope of the present invention.

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise than as specifically described.

1. A method for enhanced efficiency in meeting staffing requirements, comprising:
receiving one or more staffing requirements for employment positions from an employer;
preparing one or more candidate lists, wherein each candidate list identifies one or more available employee candidates meeting the staffing requirements from each of a plurality of staffing agencies;
preparing credential information for each available employee candidate; and
sending the candidate lists and corresponding credential information to the employer.

2. The method of claim 1, wherein the staffing requirements require at least one of a license, a certification, a particular skill and a particular level of experience.

3. The method of claim 2, wherein preparing one or more candidate lists comprises:
sending the staffing requirements to each of the staffing agencies; and
receiving one or more candidate lists from each of the staffing agencies.

4. The method of claim 3, wherein the employer comprises one or more health care providers.

5. The method of claim 4, wherein the available employee candidates comprise at least one of nurses, lab technicians, and health care workers.

6. The method of claim 3, wherein the available employee candidates are selected from a database.

7. The method of claim 4, wherein the credential information comprises at least one of education information, training information, relevant work experience, and electronic images.

8. The method of claim 7, wherein the electronic images comprise images of documents relating to the qualification of the corresponding available employee candidate.

9. The method of claim 8, wherein the documents comprise at least one of licenses, certification and diplomas.

10. The method of claim 3, wherein preparing one or more candidate lists further comprises processing the staffing requirements prior to sending the staffing requirements to the staffing agencies.

11. The method of claim 3, wherein the credential information is retrieved from a database.

12. The method of claim 3, further comprising storing the prepared candidate lists in a database.

13. The method of claim 11, further comprising storing the prepared credential information in the database.

14. The method of claim 13, wherein preparing one or more candidate lists comprises:
matching the staffing requirements with one or more of the prepared candidate lists; and
retrieving the matched prepared candidate lists from the database.

15. The method of claim 14, wherein the prepared candidate lists are periodically updated from information received from the staffing agencies.

16. The method of claim 2, wherein a time required to receive one or more staffing requirements from an employer, prepare one or more candidate lists, prepare credential information for each available employee candidate and send the candidate list and corresponding credential information to the employer is less than one minute.

17. The method of claim 3, wherein the employment positions comprise temporary employment positions.

18. The method of claim 3, wherein the employment positions must be filled within a short time frame.

19. The method of claim 3, further comprising maintaining available employment candidate information and the credential information in a database.

20. The method of claim 3, further comprising maintaining performance information for one or more of the available employee candidates in a database.

21. The method of claim 20, wherein the performance information is received from the employer.

22. The method of claim 3, further comprising maintaining billing information for one or more of the available employee candidates in a database.

23. The method of claim 3, further comprising scheduling interviews for one or more of the available employee candidates.

24. The method of claim 3, wherein the employer comprises a plurality of employers.

25. A computer system for enhanced efficiency in meeting staffing requirements, comprising:
one or more processors; and
a computer readable medium connected to the processors, the computer readable medium including processor instructions configured to be read by the processors and thereby cause the processors to:
receive one or more staffing requirements for employment positions from an employer;
prepare one or more candidate lists, wherein each candidate list identifies one or more available employee candidates selected based on the staffing requirements from each of a plurality of staffing agencies;
prepare credential information for each available employee candidate; and
send the candidate lists and corresponding credential information to the employer.

26. The computer system of claim 25, wherein the staffing requirements require at least one of a license, a certification, a particular skill, and a particular level of experience.

27. The computer system of claim 26, wherein the computer readable medium including processor instructions is further configured to be read by the processors and thereby cause the processors to:
send the staffing requirements to each of the staffing agencies; and
receive one or more candidate lists from each of the staffing agencies.

28. The computer system of claim 27, wherein the employer comprises one or more health care providers.

29. The computer system of claim 28, wherein the available employee candidates comprise at least one of nurses, lab technicians, and health care workers.

30. The computer system of claim 27, wherein the available employee candidates are selected from a database.

31. The computer system of claim 28, wherein the credential information comprises at least one of education information, training information, relevant work experience, and electronic images.

32. The computer system of claim 31, wherein the electronic images comprise images of documents relating to the qualification of the corresponding available employee candidate.

33. The computer system of claim 32, wherein the documents comprise at least one of licenses, certification and diplomas.

34. The computer system of claim 27, wherein the computer readable medium including processor instructions is further configured to be read by the processors and thereby cause the processors to process the staffing requirements prior to sending the staffing requirements to the staffing agencies.

35. The computer system of claim 27, wherein the credential information is retrieved from a database.

36. The computer system of claim 27, wherein the computer readable medium including processor instructions is further configured to be read by the processors and thereby cause the processors to store the prepared candidate lists in a database.

37. The computer system of claim 35, wherein the computer readable medium including processor instructions is further configured to be read by the processors and thereby cause the processors to store the prepared credential information in the database.

38. The computer system of claim 36, wherein the computer readable medium including processor instructions is further configured to be read by the processors and thereby cause the processors to:
match the staffing requirements with one or more of the prepared candidate lists; and
retrieve the matched prepared candidate lists from the database.

39. The computer system of claim 38, wherein the prepared candidate lists are periodically updated from information received from the staffing agencies.

40. The computer system of claim 26, wherein a time required for the processors to receive one or more staffing requirements from an employer, prepare one or more candidate lists, prepare credential information for each available employee candidate and send the candidate list and corresponding credential information to the employer is less than one minute.

41. The computer system of claim 27, wherein the employment positions comprise temporary employment positions.

42. The computer system of claim 27, wherein the computer readable medium including processor instructions is further configured to be read by the processors and thereby cause the processors to maintain available employee candidate information and the credential information in a database.

43. The computer system of claim 27, wherein the computer readable medium including processor instructions is further configured to be read by the processors and thereby cause the processors to maintain performance information for one or more of the available employee candidates in a database.

44. The computer system of claim 43, wherein the performance information is received from the employer.

45. The computer system of claim 27, wherein the computer readable medium including processor instructions is further configured to be read by the processors and thereby cause the processors to maintain billing information for one or more of the available employee candidates in a database.

46. The computer system of claim 27, wherein the computer readable medium including processor instructions is further configured to be read by the processors and thereby cause the processors to schedule interviews for one or more of the available employee candidates.
